(19) United States
(12) Patent Application Publication
(10) Pub. No.: US 2015/0347345 A1
(43) Pub. Date: Dec. 3, 2015

(54) GEN3 PCI-EXPRESS RISER

(71) Applicant: CIRRASCALE CORPORATION, POWAY, CA (US)

(72) Inventors: STEPHEN V.R. HELLRIEGEL, BAINBRIDGE ISLAND, WA (US); JUSTIN SEARCY, San Diego, CA (US); DAVID DRIGGERS, SAN DIEGO, CA (US); HELMUT FRITZ, Santee, CA (US)

(73) Assignee: CIRRASCALE CORPORATION, Poway, CA (US)

(21) Appl. No.: 14/701,272

(22) Filed: Apr. 30, 2015

Related U.S. Application Data
(60) Provisional application No. 61/986,813, filed on Apr. 30, 2014.

(51) Int. Cl. G06F 13/40; G06F 13/42

(52) U.S. Cl. CPC G06F 13/4081; G06F 13/4221

(57) ABSTRACT

A Gen3 PCIe Riser consisting of four PCIe x16 slots, a PCIe switch, external power, a remote programming interface, and a PCIe edge connector. The PCIe switch is programmed to allow any PCIe device installed in a PCIe slot to communicate directly through the switch with another PCIe device installed in another PCIe slot on the Riser without using the processing power of a Central Processing Unit thereby increasing system efficiency. In alternative embodiments, two Gen3 PCIe Risers are cross-connected to allow for more direct communication between any PCIe devices installed in the system. External power is connected when the PCIe devices require more power than available from a standard PCIe slot. The external programming interface allows for the configuration of the PCIe switch to be modified to meet system demands.

### RELATED APPLICATIONS

This application is a conversion of, and claims the benefit of priority to, U.S. Provisional Patent Application Ser. No. 61/986,813, entitled “Gen3 PCI-Express Riser”, filed Apr. 30, 2014, and currently co-pending.

### FIELD OF THE INVENTION

The present invention relates generally to computer systems. The present invention is more particularly useful as device to reduce processing demands on a Central Processing Unit (CPU) in a computer system by allowing devices connected to the present invention to communicate with each other without using the CPU thereby allowing it to perform other tasks while the connected devices communicate with each other.

### BACKGROUND OF THE INVENTION

The expansion card in the computing environment is typically a printed circuit board that can be inserted into an expansion slot. Expansion slots are connected to the computer system by an expansion bus, which moves information between the internal hardware of a computer system, including the Central Processing Unit (CPU), Random Access Memory (RAM), and other peripheral devices. Expansion slots are located on a computer motherboard, a backplane, or a riser card. The expansion slots allow functionality to be added to a computer by allowing an installed expansion card to communicate with the processor, other expansion cards, and internal hardware native to the computer.

The primary purpose of an expansion card is to provide or expand on features not offered by the motherboard. In the early days of personal computers, motherboards did not have integrated graphics, hard drive controllers, sound cards, or network cards requiring the addition of expansion cards to perform these critical functions. Expansion slots allowed cards with dedicated functions to be installed, thereby adding to the computer's capabilities.

Originally, the computer controlled the transfer of data where its efforts included interpreting, receiving, and sending out the data. Later on, a bus mastering device was created. It essentially has the capability of controlling its own transfer of data to another device, allowing the processor to focus on other tasks. In essence, this freed up the computer, allowing for more efficiency.

IBM introduced what would retroactively be called the Industry Standard Architecture (ISA) bus in 1981. The parallel 16-bit ISA bus allowed for the addition of necessary functions that were not included on the motherboard. This bus was difficult to work with since a person needed in-depth knowledge of the motherboard and the expansion card to configure jumpers and switches to match the settings in the expansion card's driver since the ISA bus was so closely linked to the speed of the processor, which varied from computer to computer. Also, the input/output (I/O) bandwidth of the ISA bus was limited due to the clock speed limitations of the physical design of the connectors. As time progressed, it became apparent that the architecture of the ISA bus had become a limiting factor in a computer's performance and a new architecture was needed.

In the early 1990s, the I/O bandwidth of the ISA bus was becoming a critical bottleneck for graphics. The need for faster graphics was being driven by the ever increasing use of Graphical User Interfaces (GUI), which included computer games. In response, the industry started developing and adopting different standards in an attempt to increase bus speeds and data throughput. The ISA standard was modified in 1988 to create the Extended ISA (EISA) standard, which is a 32-bit bus allowing for higher bus speeds and data throughput. Other standards were developed by manufacturers such as HP and IBM, but these standards usually were used only by the manufacturer that created it.

Also in the early 1990s, the VESA Local Bus (VLB) was introduced and designed to work with ISA and EISA slots to provide increased performance. The VLB and the ISA/EISA slots split the work load allowing the slower busses to handle lower level tasks while the VLB handled higher level tasks. The VLB also had its share of drawbacks. The design of the VLB depended specifically on the structure of the Intel 80486 CPU's memory bus design. When Intel introduced the Pentium© processor, there were major differences in its bus designs and was not easily adaptable to the VLB design. Most motherboards had only one or two VLB slots due to the increased size of the connectors. This became a problem if the computer system required multiple expansion cards with increased performance. The VLB also had reliability problems due to strict electrical limitations. These limitations led to electrical glitches involving the CPU, memory, and other expansion cards. The VLB also had limited scalability due to it being tightly coupled to the bus speeds of the processor itself. As processor speeds increased, the design limitations of the VLB did not allow it to maintain signal integrity when moving data at the higher rate. Lastly, VLB cards were notoriously large for the functions they performed. Due to the increased size, excessive force was needed to install or remove the card, usually over-stressing the motherboard and the card itself leading to premature failure of the motherboard, the card, or both.

By 1996, VLB was all but replaced by the Peripheral Component Interface (PCI) standard. The PCI standard was first developed in 1992 by Intel. PCI greatly expanded the data bus architecture with 32-bit and 64-bit implementations. The size of the connectors was similar to the earlier ISA connectors, thereby removing the physical limitations of the VLB. Typical PCI cards used in PCs include network cards, sound cards, phone modems, USB expansion cards, serial/parallel port cards, TV tuner cards, and disk controllers. As with earlier slot types, growing bandwidth requirements by video cards outgrew the capabilities of the PCI bus leading to the introduction of the Accelerated Graphics Port (AGP) in 1996, itself a superset of PCI.

AGP consisted of a dedicated bus between the AGP slot and the processor rather than sharing the PCI bus. This resulted not only in increased throughput due to the dedicated bus, but the bus could run at higher clock speeds, thereby further increasing throughput. AGP also separated the data bus from the address bus, thereby allowing it to receive an address on the address bus while simultaneously sending data on the data bus.

The next step of PCI development was the PCI Extended (PCI-X) standard, developed in 1998 by a consortium of PC manufacturers. It is a 64-bit bus capable of moving more than 1 gigabyte per second (GB/s). It was the last version using a parallel structure before the industry moved to high speed serial designs. PCI-X was mainly used in servers due to its higher clock speeds and was easy to implement due to it using the same protocol as PCI. However, the cost of implementing PCI-X was high due to the need to create a 64-bit bus on the motherboard, which takes up valuable space. It has been replaced in modern designs by PCI-Express (PCIe).

PCIe was created in 2004 to replace the PCI and PCI-X standards. It is a high speed serial bus having one device on each endpoint of the connection. PCIe switches can create multiple endpoints out of one to allow sharing of one endpoint with multiple devices with each device having a dedicated path to the switch. This concept is similar to Universal Serial Bus (USB) hubs and Ethernet switches in that one input is turned into many outputs. PCIe has many advantages over earlier standards. These include higher maximum system bus throughput, lower I/O pin count, smaller physical footprint on the motherboard, better performance-scaling for bus devices, a more detailed error detection and reporting mechanism, and native hot-plug functionality. More recent versions support hardware I/O virtualization. PCIe version 3.0 is the latest standard that is in production and available on mainstream PCs. PCIe version 4.0 was announced on Nov. 29, 2011, with final specifications expected to be released in late 2014 or 2015.

PCIe is based on a point-to-point architecture, with separate serial links connecting every device to the host, typically through a switch, similar to an Ethernet switch. It supports full-duplex communication between any two endpoints, with no inherent limitation on concurrent access across multiple endpoints. Due to its serial nature, PCIe communication is encapsulated in packets as compared to PCI and PCI-X, which is purely parallel. Interference and signal degradation are common in parallel connections. Poor materials and crossover signal from nearby wires translate into noise, which slows the connection down. The additional width of a PCI-X bus means it can carry more data, which can generate even more noise. The PCI protocol also does not prioritize data, so more important data can get caught in the bottleneck when lower priority data is serviced by the system.

A packet is one unit of binary data capable of being routed through a computer network. To improve communication performance and reliability, each message sent between two network devices is often subdivided into packets by the underlying hardware and software. The receiving device is responsible for re-assembling individual packets into the original message, by stripping out transport related information then concatenating the data in the packets into the correct sequence.

PCIe devices communicate via a logical connection called an interconnect or link. A link is a point-to-point communication channel between two PCIe ports, allowing both to send/receive ordinary PCI-requests and interrupts. At the physical level, a link is composed of one or more lanes. Lane counts are written with an ‘x’ prefix, with x16 being the largest size currently in common use. Low-speed peripherals use a single-lane (x1) link, while a graphics adapter typically uses a much wider, and thus faster, 16-lane (x16) link. The PCIe link between two devices can consist of anywhere from 1 to 32 lanes. A lane is composed of two differential signaling pairs: one pair for receiving data, the other for transmitting. Thus, each lane is composed of four wires or signal traces. Physical PCIe slots may contain from one (1) to thirty two (32) lanes, in powers of two (1, 2, 4, 8, 16, and 32).

All sizes of x4 and x8 PCIe cards are allowed a maximum power consumption of 25 W. All x1 cards are initially 10 W; full-height cards may configure themselves as ‘high-power’ to reach 25 W, while half-height x1 cards are fixed at 10 W. All sizes of x16 cards are initially 25 W; like x1 cards, half-height cards are limited to this number while full-height cards may increase their power after configuration. They can use up to 75 W, though the specification demands that the higher-power configuration be used for graphics cards only, while cards of other purposes are to remain at 25 W. Optional connectors add 75 W or 150 W of power for up to 300 W total.

The main limitation of expansion slots in computers is the number of available slots for the given size of motherboard. Smaller motherboards may only contain 2 or 3 slots where larger boards may contain up to 6. If the function of a computer system depends on the installed expansion cards, there may not be sufficient slots available to incorporate all of the necessary functions into the system. To support the addition of expansion cards beyond the number of available expansion slots on the motherboard, PCIe switches have been developed to allow multiple expansion cards to use a single PCIe slot on the motherboard.

In a network, latency, a synonym for delay, is an expression of how much time it takes for a packet of data to get from one designated point to another. In some usages, latency is measured by sending a packet that is returned to the sender and the round-trip time is considered the latency. The latency assumption seems to be that data should be transmitted instantly between one point and another with little or no delay. Latency is usually attributed to propagation issues, the transmission medium, routers, storage delays, and other computer processes. In a computer system, latency is often used to mean any delay or waiting that increases real or perceived response time beyond the response time desired. Specific contributors to computer latency include mismatches in data speed between the CPU and I/O devices as well as inadequate data buffers.

In a typical computer setup, communication between devices connected to expansion slots must send data to each other by using the processor, thereby preventing the processor from performing other tasks during the data transfer. If the amount of data to be transferred is large or continuous, the latency associated with the transfer can result in a significant amount of delay and a reduction in system performance. In cases of large data transfers, the system may appear to be frozen with no response to the keyboard or mouse until the transfer is complete.

Direct Memory Access (DMA) is a method that allows an I/O device to send or receive data directly to or from the main memory, bypassing the CPU to speed up memory operations. In older computers, four DMA channels were numbered 0, 1, 2, and 3. A DMA channel enables a device to transfer data without exposing the CPU to a work overload. Without the DMA channels, the CPU copies every piece of data using a peripheral bus from the I/O device. Using a peripheral bus occupies the CPU during the read/write process and does not allow other work to be performed until the operation is completed. With DMA, the CPU can process other tasks while data transfer is being performed. The transfer of data is first initiated by the CPU. During the transfer of data between the DMA channel and I/O device, the CPU performs other tasks thereby increasing the efficiency of the system. When the data transfer is complete, the CPU receives an interrupt request from the DMA controller signaling to the CPU that the transfer is complete. DMA can also be used for “memory to memory” copying or moving of data within memory. DMA can offload expensive memory operations, such as large copies or scatter-gather operations, from the CPU to a dedicated DMA engine further increasing the efficiency of the system.

PCI architecture has no central DMA controller, unlike ISA. Instead, any PCI component can request control of the bus (“become the bus master”) and request to read from and write to system memory. More precisely, a PCI component requests bus ownership from the PCI bus controller, which will arbitrate if several devices request bus ownership simultaneously, since there can only be one bus master at one time. When the component is granted ownership, it will issue normal read and write commands on the PCI bus, which will be claimed by the bus controller and will be forwarded to the memory controller using a scheme which is specific to every chipset.

In today's computing environment, the demands placed on computer systems are forever increasing. Computers, especially servers, are tasked with many services to be provided at the same time. One area of demand is video creation, editing, and display. To support this, many systems are populated with more than one video card or Graphics Processing Unit (GPU). In a typical PCIe system, the GPUs coordinate their operations by communicating with each other through the processor. In some instances, GPUs use a direct connection between the units to help coordinate their operation, but the cards must be designed to communicate in this manner and the cards must be identical. If the system is dominated by GPUs, additional functions performed by the system may experience delay, or latency, when the GPUs communicate with each other. To overcome this limitation, an adapter card allowing PCIe cards to communicate directly with each other without using the processor would be advantageous. Further, it would be advantageous to provide an adapter card allowing for the connection of additional power to the adapter card to ensure adequate power available to each card attached to the adapter card. It would be further advantageous to provide an adapter card that allows the adapter card's local intelligence to be programmed to optimize system performance. It would also be advantageous to provide a system where the adapter card is capable of having a direct connection to another adapter card, further increasing the speed of communication between the cards.

### SUMMARY OF THE INVENTION

The Gen3 PCIe Riser of the present invention includes four (4) PCIe x16 Slots and an edge connector allowing the Riser to be inserted into a PCIe slot located on a computer motherboard. The four (4) PCIe x16 Slots and the edge connector have a dedicated bus interface with a PCIe switch thereby removing the possibility of data corruption by multiple devices attempting to use the bus simultaneously. The PCIe switch is programmed to allow various PCIe devices inserted into the PCIe x16 Slots to communicate with each other through the PCIe switch instead of routing the data traffic through the CPU.

The Gen3 PCIe Riser also consists of an external power connection and a remote programming interface. The external power connection allows for up to 150 watts of power to be supplied to a PCIe device connected to the Riser. The remote programming interface is a typical way to program and configure the PCIe switch however other methods exist.

In an embodiment, when at least two Gen3 PCIe Risers are installed in the same computer system, the Risers consist of a cross-connect connector allowing for even more direct communication between PCIe devices installed on two different Gen3 PCIe Risers by bypassing the PCIe root bridge. In an alternative embodiment, two (2) Gen3 PCIe Risers are connected by way of a cross-connect designed to cooperate with a PCIe slot on each Riser instead of dedicated cross-connect connector.

When installed in a system large enough to hold two (2) Gen3 PCIe Risers, the Risers may be inserted directly into a local PCIe slot causing the Riser to be perpendicular to the system motherboard. Alternatively, a Gen3 PCIe Riser may be mounted parallel to the system motherboard where an adapter is used to connect the edge connector of the Riser to a local PCIe slot on the motherboard.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a diagram of a traditional PCI interface layout showing the use of a parallel bus interfaced to multiple PCI slots and a bus controller;

FIG. 2 is a diagram view of a modern PCIe interface layout showing a dedicated data channel from each PCIe slot to a PCIe switch and a data channel from the PCIe switch to a host CPU;

FIG. 3 is a diagram view of an embodiment of the present invention showing a PCIe Riser Card having four (4) PCIe slots connected to a PCIe switch and directional lines showing data flow from one PCIe slot to another without the use of the host CPU;

FIG. 4 is a diagram view of an embodiment of the present invention showing a PCIe Riser Card interfaced to a local PCIe slot. The riser card shows the PCIe slots, the data busses, the PCIe switch, external power, and a remote programming interface. The host side shows the local PCIe slot, the PCIe Root Bridge, a data bus controller, and a CPU;

FIG. 5 is a diagram view of an embodiment of the present invention showing two (2) PCIe Riser Cards, each one connected to a local PCIe slot, which in turn is connected to a PCIe Root Bridge;

FIG. 6 is a diagram view of an embodiment of the present invention showing two (2) PCIe Riser Cards, as depicted in FIG. 5, also consisting of a data cross-connect connecting the two (2) PCIe Riser Cards directly to each other by way of dedicated connectors located on each PCIe Riser Card. The connectors tie to the local PCIe switch by connecting to the data bus of one of the PCIe slots;

FIG. 7 is a diagram view of an embodiment of the present invention showing two (2) PCIe Riser Cards, as depicted in FIG. 5, also consisting of a data cross-connect connecting the two (2) PCIe Riser Cards directly to each other by way of a connection between one (1) PCIe slot on each PCIe Riser Card;

FIG. 8 is a perspective view of a Server chassis consisting of a server motherboard, a PCIe Riser Card mounted directly into a local PCIe slot, and an expansion card inserted into one of the PCIe slots on the PCIe Riser Card;

FIG. 9 is a perspective view of a Server chassis consisting of a server motherboard, a PCIe Riser Card mounted parallel to the server motherboard and connected to the local PCIe slot by way of an intermediate connector, and an expansion card inserted into one of the PCIe slots on the PCIe Riser Card;

FIG. 10 is a perspective view of a Server chassis consisting of a server motherboard, two (2) PCIe Riser Cards mounted parallel to the server motherboard, each one connected to a local PCIe slot;

FIG. 11 is a top view of an embodiment of the present invention showing a circuit card consisting of four (4) PCIe slots, a PCIe switch, an external power connector, a remote programming connector, and an edge connector allowing the Gen3 PCIe Riser to be inserted into a local PCIe slot;

FIG. 12 is a top view of four (4) PCIe slots, a PCIe switch, an external power connector, a remote programming connector, and an edge connector allowing the Gen3 PCIe Riser to be inserted into a local PCIe slot. Also included is a cross connect allowing for direct connection of two (2) Gen3 PCIe Risers.

### DETAILED DESCRIPTION

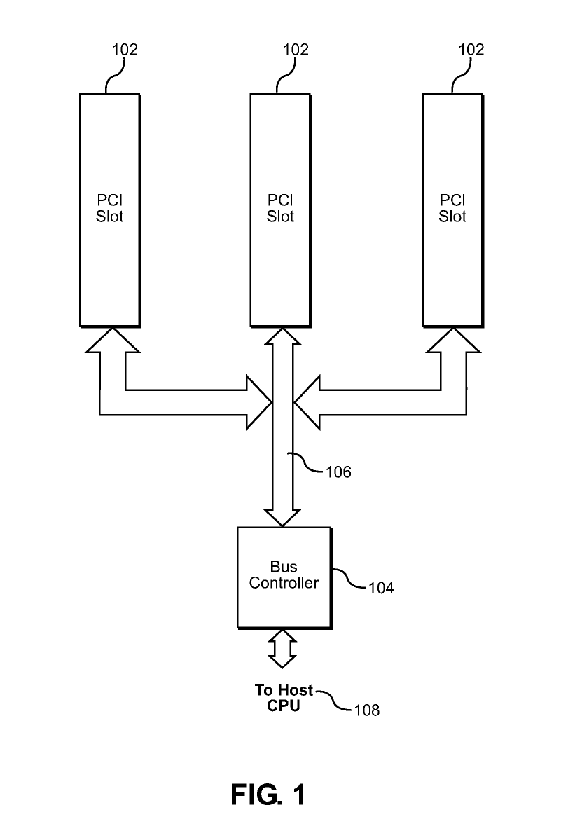

Referring to FIG. 1, a diagram of a traditional PCI interface is shown. PCI slots 102 are connected to Bus Controller 104 by way of PCI bus 106. The PCI bus 106 can be either 32-bits or 64-bits wide. Bus Controller 104 is also connected to a host CPU 108. PCI slots 102 are connected in parallel manner. More specifically, PCI Slots 102 share the same PCI bus 106. Only one PCI Slot 102 may communicate with the Bus Controller at a time or there will be contention on the PCI bus 106. If there is contention, meaning more than one PCI slot 102 is attempting to communicate with the Bus Controller 104 at the same time, the data being placed on the PCI bus will be corrupt. To prevent data corruption, bus controller 104 controls which PCI slot 102 is allowed to place data on the PCI bus 106. When that data transfer is complete, bus controller 106 then allows another data transfer from a different PCI slot 102 or the same PCI slot 102 that originally transferred data, again allowing only one PCI slot 102 at a time to place data on the PCI bus 106.

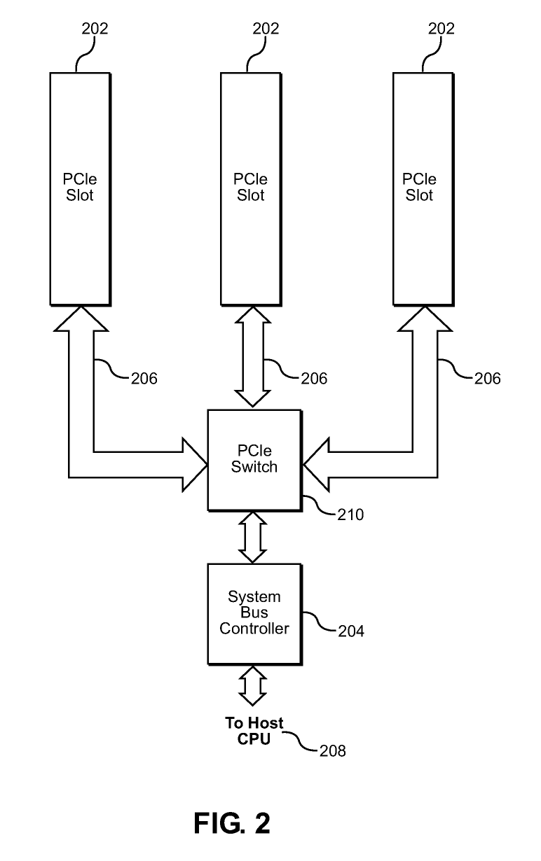

Referring to FIG. 2, a diagram of a PCIe interface is shown. PCIe slots 202 are connected to PCIe switch 210 by way of PCIe buses 206. Each PCIe slot 202 has a dedicated PCIe bus 206 to the PCIe switch 210 thereby eliminating the need for bus mastering and minimizing the potential of data corruption. PCIe switch 210 also communicates with system bus controller 204, which in turn communicates with the host CPU 208. PCIe switch 210 may be a PEX8780 from PLX Technology Inc.

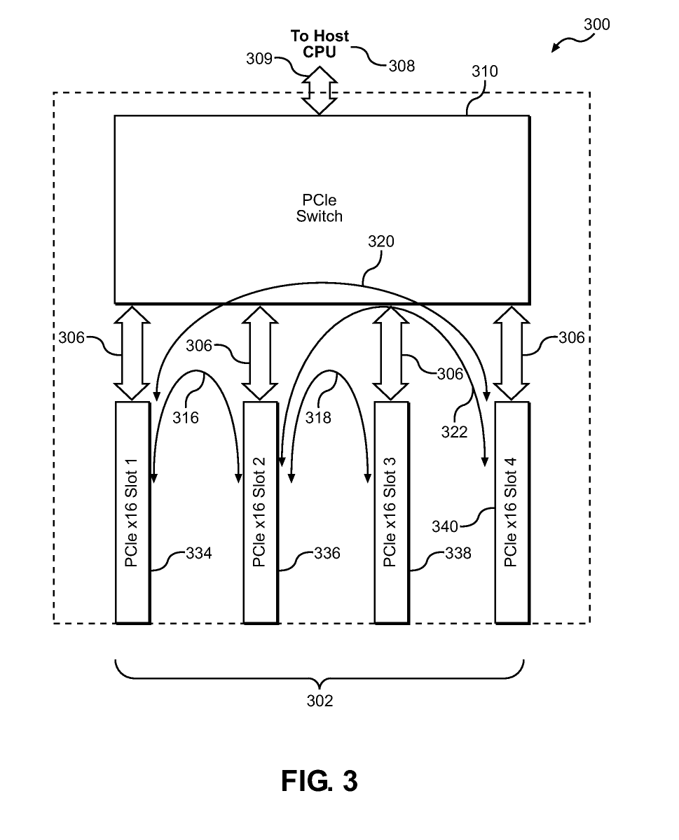

Referring to FIG. 3, a diagram of a Gen3 PCIe Riser of the present invention is shown and generally designated 300. Four (4) PCIe x16 slots 302 connect to a PCIe switch 310 through PCIe buses 306. PCIe switch 310 in turn connects to host CPU 308 through PCIe bus 309. In a preferred embodiment, PCIe switch 310 is implemented as an Application Specific Integrated Circuit (ASIC). An ASIC is an integrated circuit (IC) customized for a particular use as opposed to an IC designed for general purpose use. Since the IC is customized, particular functions may be designed into the IC and unused functions, common in general purpose ICs, can be left out of the design thereby creating an IC efficient in both size and performance. In the present invention, the PCIe switch 310 is designed to allow for arbitrary PCIe devices 342 to communicate with each other without going through the host CPU 308 thereby minimizing the CPU's workload. The Gen3 PCIe Riser 300 uses an 80-lane PCIe switch 310 to create five (5) 16-lane (x16) PCIe slots 302. One x16 PCIe bus 309 is attached to a host CPU 308 containing a PCIe root bridge 312 (not shown), and the other four (4) x16 PCIe busses 306 are each attached to a PCIe x16 slot 302.

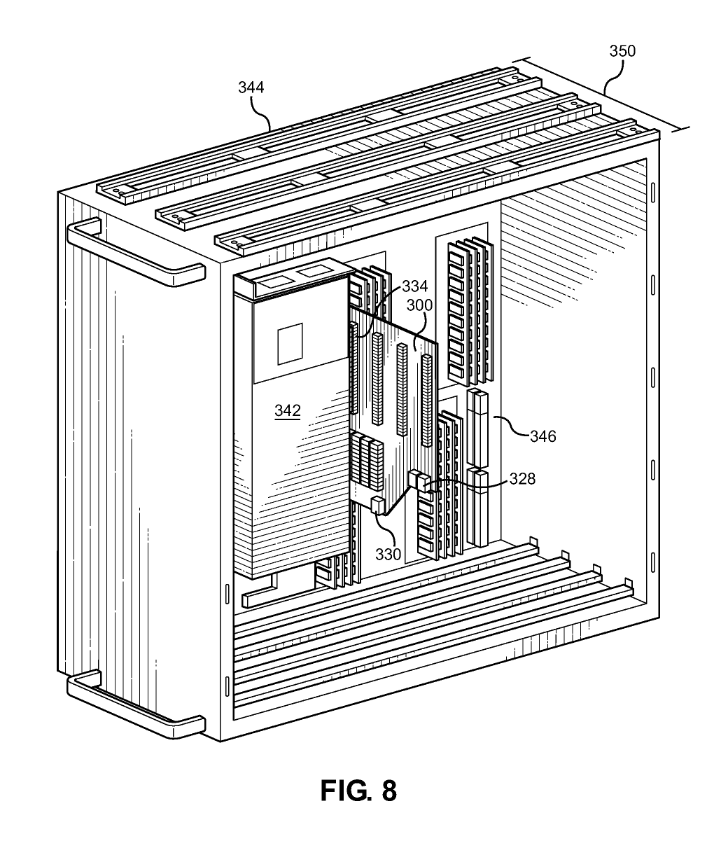

As shown in FIG. 3, the implementation of the PCIe switch 310 allows for a PCIe device 342 (not shown) in any given PCIe slot 302 to communicate with another PCIe slot 302 located on the same Gen3 PCIe Riser 300. For example, as shown by data path 316, a PCIe device 342 (see FIG. 8) installed in PCIe x16 Slot 1 334 can communicate with a PCIe device 342 (not shown) installed in PCIe x16 Slot 2 336 via only PCIe switch 310 without going through Host CPU 308. Data path 318 shows PCIe x16 slot 2 336 communicating with PCIe x16 slot 3 338. Data paths 320 and 322 show PCIe x16 slot 1 334 and slot 2 336 communicating with PCIe x16 slot 4 340 respectively.

In this implementation, PCIe switch 310 must be programmed to allow for direct communication between PCIe slots 302. When programmed for direct communication between PCIe slots 302, the operation is similar to that of DMA in that the CPU 305 is informed of the data transfer but does not participate in the actual transfer thereby allowing it to perform other tasks during the transfer. The CPU 305 is then informed when the transfer is complete. When a PCIe device 342 transmits data onto its associated PCIe bus 306, PCIe switch 310 analyzes the source and destination information contained within the data packet. If the destination of the data packet is another PCIe device 342 installed in the same Gen3 PCIe Riser, PCIe switch 310 routes the data packet onto the PCIe bus associated with the destination PCIe device 342. If the destination of the data packet is a PCIe device 342 located on another PCIe Riser 300 or some other system resource, the PCIe switch 310 routes the data packet to the PCIe root bridge 312 through local PCIe slot 314.

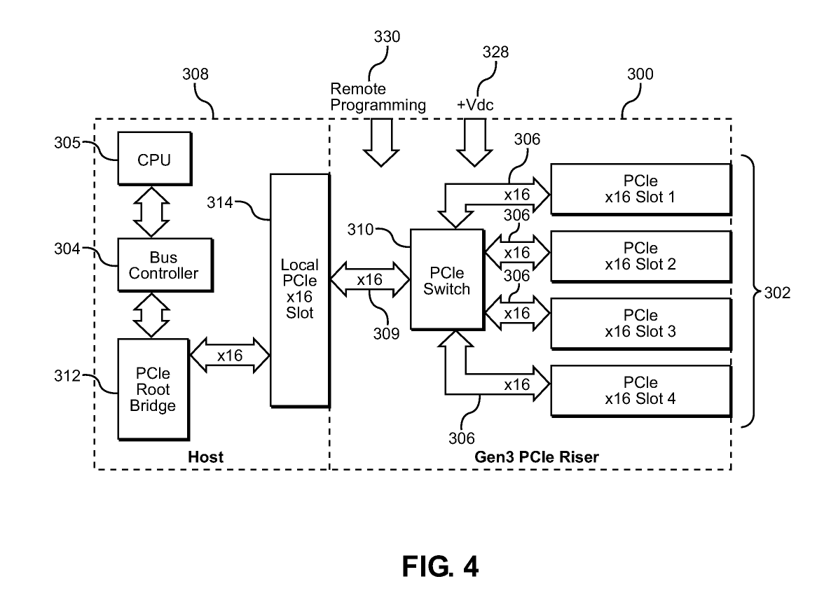

Referring now to FIG. 4, a diagram of a Gen3 PCIe Riser 300 connected to a host CPU 308 is shown. Gen3 PCIe Riser 300 is connected to host CPU 308 through local PCIe x16 slot 314. Local PCIe x16 slot 314 is also connected to the PCIe root bridge 312. It is to be appreciated by someone skilled in the art that more than one local PCIe slot may be connected to PCIe root bridge 312. PCIe root bridge 312 is connected to bus controller 304, which in turn is connected to CPU 305. Gen3 PCIe Riser 300 also consists of a remote programming interface 330 which allows for the programming of PCIe switch 310. The remote programming interface 330 may be of any form known in the industry, which includes I Squared C (I2C) and Modbus, and allows for the operation of PCIe switch 310 to be programmed to allow for, and maximize, communications between PCIe slots 302. PCIe switch 310 also is configurable through strapping pins (not shown), host software, or an optional serial Programmable Read Only Memory (PROM) (not shown). Also shown is a connection for remote power 328. Connection of an external power source (not shown) allows for the supply of up to 150 watts of power per PCIe slot 302. It is also to be appreciated by someone skilled in the art that any given PCIe device 342 (not shown) installed into a PCIe slot 302 may have its own external power connection.

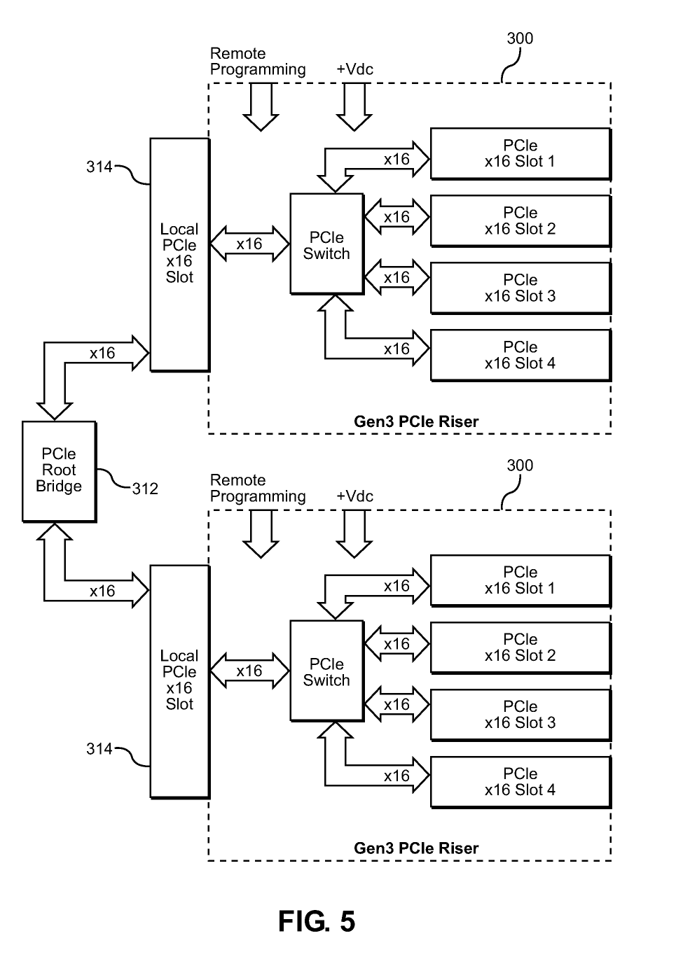

FIG. 5 is a diagram of two (2) Gen3 PCIe Risers 300 connected to PCIe root bridge 312 through local PCIe slots 314. In this implementation, it is to be appreciated that a PCIe device 342 (not shown) installed in a first Gen3 PCIe Riser 300 may only communicate with another PCIe device 342 (not shown) on a second Gen3 PCIe Riser 300 through PCIe root bridge 312.

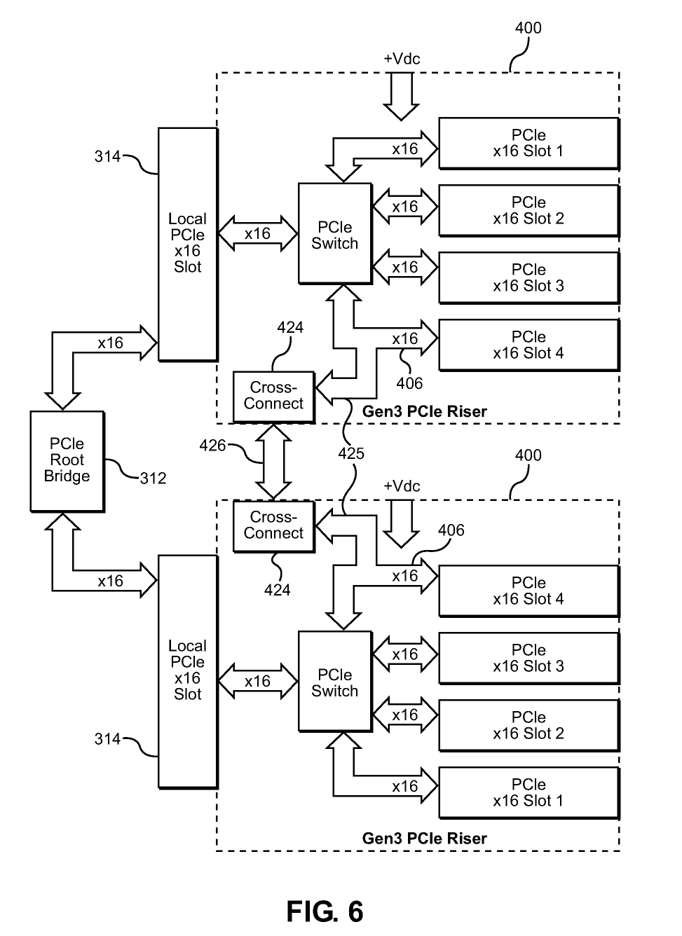

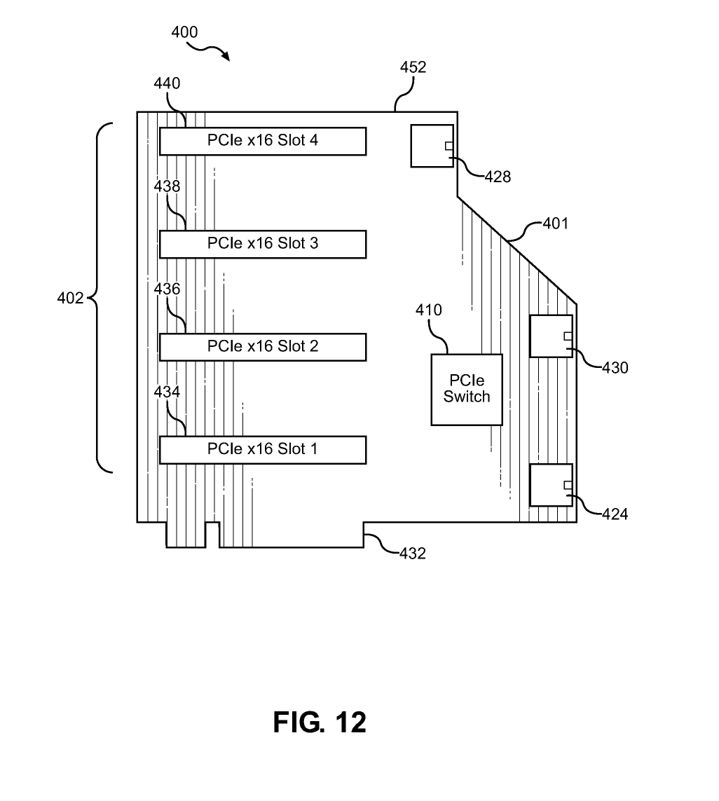

FIG. 6 is a diagram of two (2) Gen3 PCIe Risers 400 (see FIG. 12) connected to the PCIe root bridge 312 through local PCIe slots 314. This implementation also consists of a data cross connect 424 on each Riser 400. Cross connect 424 interfaces with PCIe switch 410 through cross connect bus 425, which shares PCIe bus 406 associated with PCIe x16 Slot 4 440. In this implementation when two (2) Risers 400 are directly connected, PCIe x16 Slot 4 440 may not be populated with a PCIe device 342 since PCIe busses are not designed to be shared between two devices. To support cross connecting two (2) Gen3 PCIe Risers 400, both Risers 400 must be connected to each other through cross connect 424. PCIe switch 410 must be programmed to recognize the source and destination of the transmitted data to be two (2) PCIe devices 342, each one connected to a different PCIe Riser 400. When a PCIe device 342 transmits data onto its associated PCIe bus 406, PCIe switch 410 looks at the destination of the data. If the destination is a PCIe device 342 on another Gen3 PCIe Riser 400, PCIe switch 410 routes the data onto cross connect bus 425, which is connected to cross connect 424. The data passes to the other PCIe Riser 400 through the connection between cross connects 424 and onto its cross connect bus 425, then to the PCIe bus 406 associated with PCIe x16 Slot 4 440. The PCIe switch 410 on the other PCIe Riser 400 then will look at the destination of the data and route it accordingly to the proper PCIe device 342. It is to be appreciated by someone skilled in the art that a secondary PCIe switch (not shown) that interfaces between cross connect bus 425, PCIe switch 410, and the PCIe bus 406 associated with PCIe x16 Slot 4 440 may be implemented to allow for all four (4) PCIe slots 402 to be populated with a PCIe device 342. It is to be further appreciated that other gated circuitry, such as a data pass-through register, may be used instead of a secondary PCIe switch.

The two (2) Gen3 PCIe Risers 400, when programmed for such operation through remote programming interface 430 (not shown), will allow for any PCIe device 342 (not shown) on one Gen3 PCIe Riser 400 to communicate with a PCIe card installed on the other Riser 400 through cross connect data path 426 thereby further conserving system resources. In this implementation, only six (6) total PCIe devices 342 may be installed unless a secondary PCIe switch or other gated circuitry is implemented allowing eight (8) total PCIe devices 342 to be installed.

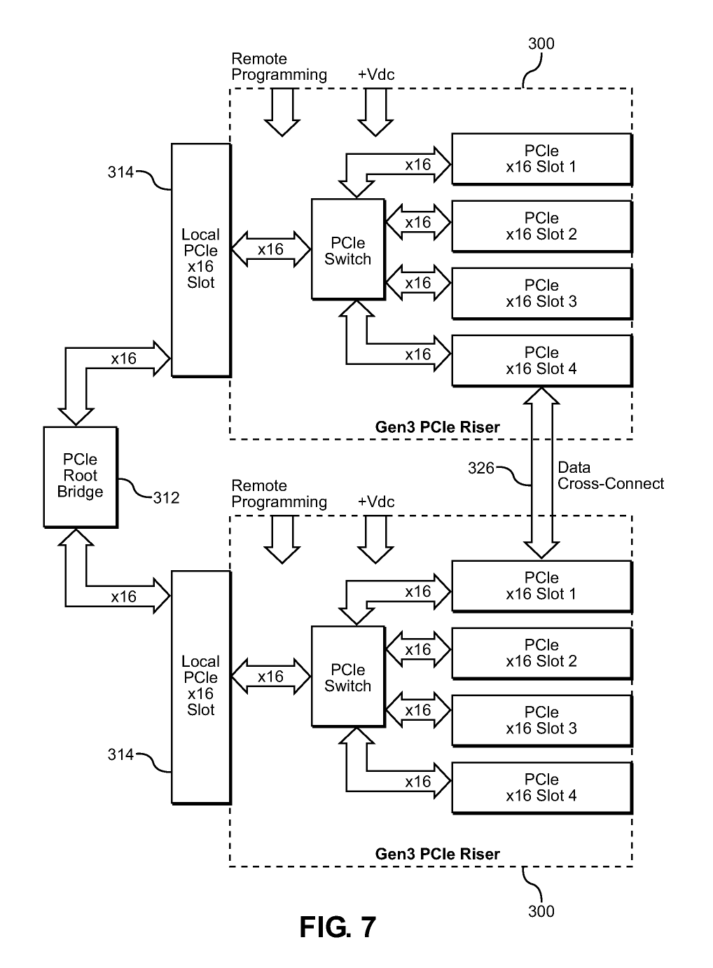

FIG. 7 is a diagram of two (2) Gen3 PCIe Risers 300 connected to the PCIe root bridge 312 through local PCIe slots 314. In this implementation, the Gen3 PCIe Risers 300 are connected to each other through data cross connect 326. Data cross connect 326 may be a cable consisting of PCIe edge connectors 332 (not shown) inserted into one of the PCIe slots 302 on each PCIe Riser 300. As shown in FIG. 7, PCIe x16 slot 4 340 on a first Gen3 PCIe Riser 300 is connected to PCIe x16 Slot 1 334 on a second Gen3 PCIe Riser 300. It is to be appreciated by someone skilled in the art that any PCIe slot 302 on a first Gen3 PCIe Riser 300 may be connected to any PCIe slot 302 on a second Riser 300. To support this operation, PCIe switch 310 must be programmed to recognize the direct connection between the Gen3 PCIe Risers 300.

Referring now to FIG. 8, a perspective view is shown of a computer chassis 344 with a motherboard 346 mounted inside the chassis 344. Installed onto the motherboard 346 is a Gen3 PCIe Riser 300 inserted in a local PCIe slot 314 (not shown). A PCIe device 342 is inserted into PCIe x16 Slot 1 334. Also shown are connectors for external power 328 and remote programming interface 330. It is to be appreciated by someone skilled in the art that up to four (4) PCIe devices 342 may be installed into the Gen3 PCIe Riser 300. This orientation of the Riser 300 is typically used with full size chassis 344 having a chassis height 350 that exceeds the overall height of the motherboard 346 and Gen3 PCIe Riser 300 when combined. If the PCIe device requires additional power, a connection is made to the connector for external power 328. Alternatively, PCIe device 342 may have its own external connection for power (not shown).

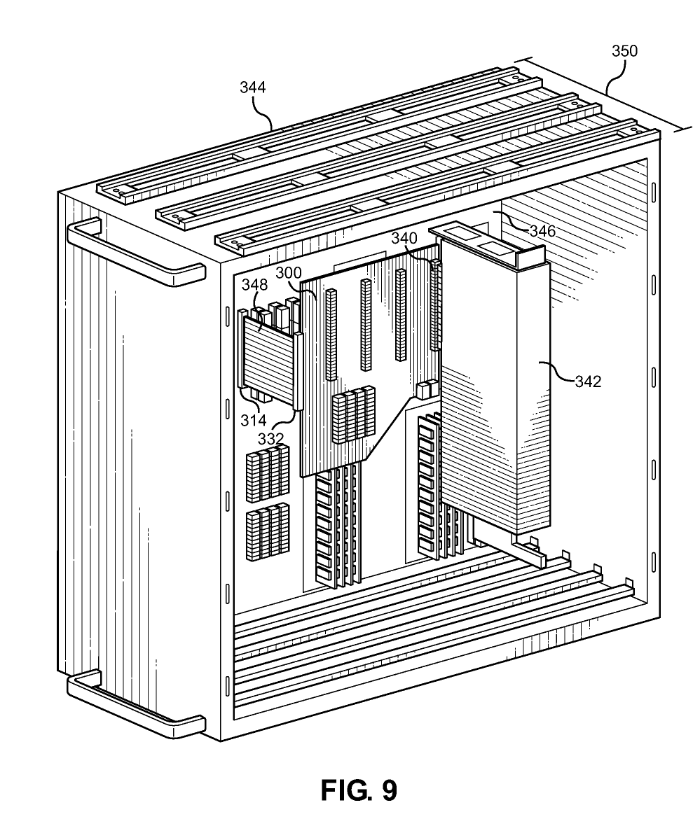

FIG. 9 is a perspective view of a computer chassis 344 with a motherboard 346 mounted inside. Gen3 PCIe Riser 300 is mounted parallel to motherboard 346 and connected to local PCIe slot 314 by way of a PCIe slot adapter 348. Slot adapter 348 may be constructed from a flexible cable or may be a rigid body with connectors oriented at a right angle and connects between edge connector 332 and local PCIe slot 314. It is to be appreciated by someone skilled in the art that slot adapter 348 has one end similar to edge connector 332 to insert into local PCIe slot 314 and the other end similar to local PCIe slot 314 for edge connector 332 to insert into. Also shown is a PCIe device 342 mounted into PCIe x16 slot 4 340. This orientation of Gen3 PCIe Riser 300 is typically used with a chassis 344 having a reduced chassis height 344 such as a low profile server or a blade server.

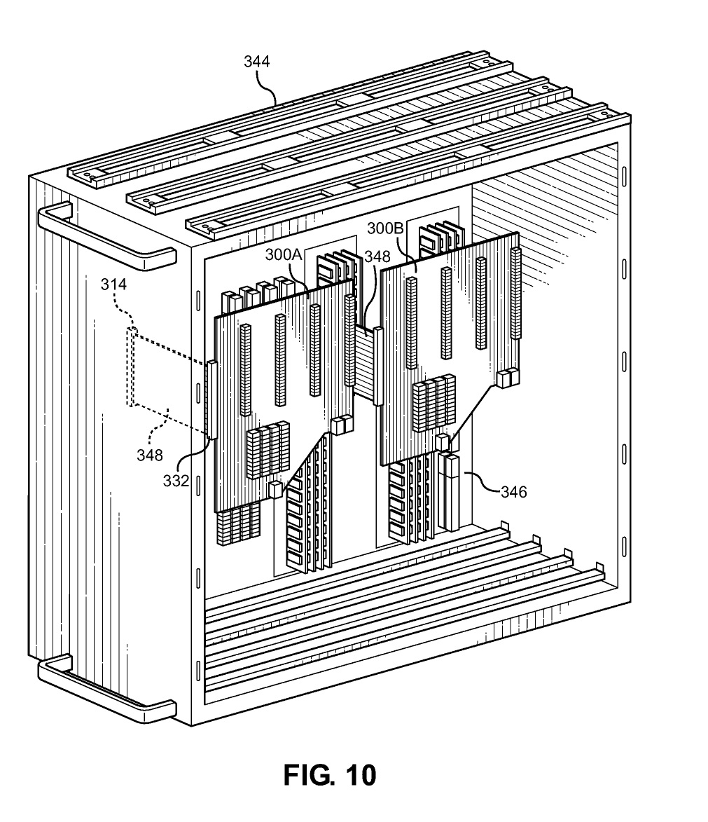

FIG. 10 is a perspective view of a computer chassis 344 with a motherboard 356 mounted inside. A first Gen3 PCIe Riser 300a and a second Gen3 PCIe Riser 300b are mounted parallel to motherboard 356. Edge connector 332 on First Gen3 PCIe Riser 300a connects to local PCIe slot 314 on motherboard 346 by way of slot adapter 348. Second Gen3 PCIe Riser 300b connects to motherboard 346 in the same manner to a different local PCIe slot (not shown) on motherboard 346. It is to be appreciated that up to eight (8) total PCIe devices 342 (not shown) may be inserted into chassis 344 using first and second Gen3 PCIe Risers 300a and 300b.

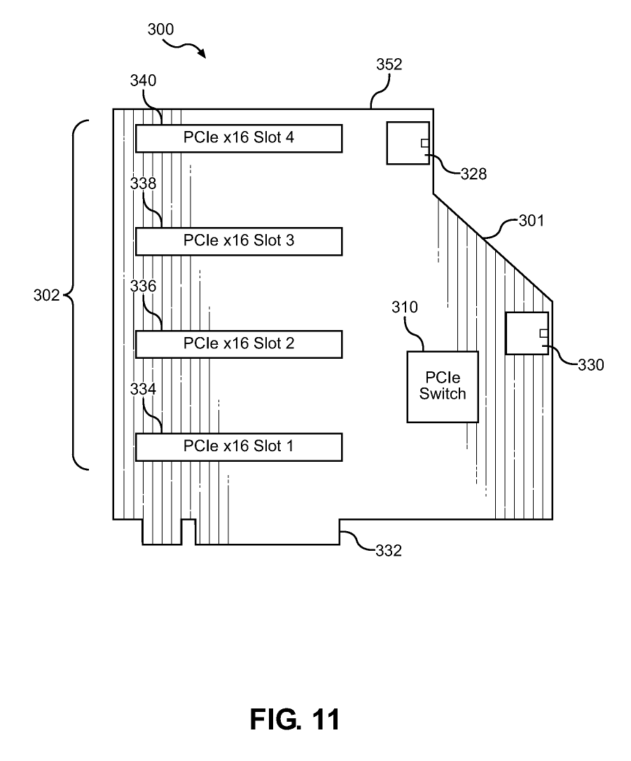

FIG. 11 is a top view of an embodiment of a Gen3 PCIe Riser of the present invention and generally designated 300. Shown are the physical locations of PCIe slots 302, PCIe switch 310, connectors for external power 328 and remote programming interface 330, and edge connector 332, all mounted on a circuit board 352. PCIe slots 302 consists of PCIe x16 Slot 1 334 located near and parallel to the bottom edge of circuit board 352. Located next to PCIe x16 Slot 1 334, when moving away from edge connector 332, is PCIe x16 Slot 2 326. PCIe x16 Slots 3 and 4 338 and 340 are similarly oriented with respect to Slot 1 334 and Slot 2 336. The spacing of the PCIe slots 302 enables the up to four (4) double width PCIe devices 342 to be installed. PCIe switch 310 is located away from the PCIe slots 302 and near the connector for remote programming interface 330. The connector for external power 328 is located near the edge of Gen3 PCIe Riser 300 furthest from edge connector 332 and distanced from PCIe slots 302.

FIG. 12 is a top view of an embodiment of a Gen3 PCIe Riser of the present invention and generally designated 400. Shown are the physical locations of PCIe slots 402, PCIe switch 410, connectors for external power 428 and remote programming interface 430, and edge connector 432, all mounted on a circuit board 452. PCIe slots 402 consists of PCIe x16 Slot 1 434 located near the bottom edge of circuit board 452. Located next to PCIe x16 Slot 1 434 when moving away from edge connector 432 is PCIe x16 Slot 2 426. PCIe x16 Slots 3 and 4 438 and 440 are similarly oriented. The spacing of the PCIe slots 402 enables the up to four (4) double width PCIe devices 342 to be installed in the system. PCIe switch 410 is located away from the PCIe slots 402 and near the connector for remote programming interface 430. The connector for external power 428 is located near the edge of Gen3 PCIe Riser 400 furthest from edge connector 432 and distanced from PCIe slots 402. Cross connect 424 is located near the remote programming interface 430.

The Gen3 PCIe Risers 300 and 400 support a homogeneous configuration of PCIe devices 342 where the devices 342 may be GPUs or non-GPUs such as the Intel Xeon Phi. Further, heterogeneous configurations of PCIe devices 342 with various functions, PCIe lane widths, and PCIe generations such as Gen1 and Gen2, are possible and fully supported.

While there have been shown what are presently considered to be preferred embodiments of the present invention, it will be apparent to those skilled in the art that various changes and modifications can be made herein without departing from the scope and spirit of the invention.

I claim:

1. A PCI-Express Riser card, comprising:
A circuit board having an edge connector;
A configurable PCI-Express switch;
A plurality of PCI-Express slots configured to receive PCI-Express devices;
A remote programming interface;
Wherein the PCI-Express switch is configured to receive
programming and configuration data through the remote programming interface.

2. The PCI-Express Riser card of claim 1, further comprising one or more external power connections.

3. The PCI-Express Riser card of claim 1, wherein the PCI-Express switch is configured to allow PCI-Express devices connected to the plurality of PCI-Express slots to communicate directly through the PCI-Express switch without going through a host controller or a host CPU.

4. The PCI-Express Riser card of claim 1, wherein the PCI-Express switch is remotely programmable during startup.

5. The PCI-Express Riser card of claim 1, wherein the PCI-Express switch is remotely programmable during normal operation.

6. The PCI-Express Riser card of claim 1, further comprising strapping pins, host software, or read only memory (ROM) modules.

7. The PCI-Express Riser card of claim 1, the card further comprising:
a data bus connecting each PCI-Express slot to the PCI-Express switch; and
a means to cross-connect one of the data busses to a data bus of a second PCI-Express Riser card.

8. A host computer system, comprising:
A motherboard having a central processing unit, a PCI-Express root bridge, and a plurality of Local PCI-Express device slots;
A plurality of PCI-Express Riser cards having a plurality of PCI-Express slots configured to receive PCI-Express devices, each Riser card connected to one of the plurality of Local PCI-Express device slots; and
a cross-connect removably attached to a PCI-Express slot on a first of the plurality of PCI-Express Riser cards and to a PCI-Express slot on a second of the plurality of PCI-Express Riser cards.

9. The host computer system of claim 8, further comprising a slot adapter configured to connect one of the plurality of Local PCI-Express slots to one of the plurality of PCI-Express Riser cards.

10. The host computer system of claim 9, wherein the slot adapter is constructed from a flexible cable or a rigid body.

11. The host computer system of claim 10, wherein the rigid body has connectors oriented at a right angle.

12. A method of operating a PCI-Express Riser card, the PCI-Express Riser card having a PCI-Express switch, a plurality of PCI-Express slots having one or more PCI-Express devices connected thereto, and an interconnecting bus, the steps consisting of:
Programming the PCI-Express switch to allow direct communication between two or more of the PCI-Express devices connected to the plurality of PCI-Express slots;
Transmitting a data packet from a PCI-Express device onto the interconnecting bus;
Analyzing the data packet to determine source and destination information contained within the data packet; and
Routing the data packet based on the source and destination information.

13. The method of operating a PCI-Express Riser card of claim 12, wherein the data packet is routed through the PCI-Express switch to another PCI-Express device connected to the PCI-Express Riser card when the source and destination information indicate the source and destination are on the same PCI-Express Riser card.

14. The method of operating a PCI-Express Riser card of claim 12, wherein the data packet is routed through the PCI-Express switch to a PCI-Express root bridge when the source and destination information indicate the source and destination are not on the same PCI-Express Riser card.

15. The method of operating a PCI-Express Riser card of claim 12, wherein the programming the PCI-Express switch occurs at startup.

16. The method of operating a PCI-Express Riser card of claim 12, wherein the programming the PCI-Express switch occurs during operation.

17. The method of operating a PCI-Express Riser card of claim 12, the Riser card having a secondary PCI-Express switch, the method further comprising the step of programming the secondary switch to allow direct communication between the Riser card and a second PCI-Express Riser card.
